(19) United States
(12) Patent Application Publication
(10) Pub. No.: US 2015/0341263 A1
(43) Pub. Date: Nov. 26, 2015

(54) ASSOCIATING INTERNET PROTOCOL (IP) ADDRESSES WITH ETHERNET VIRTUALISATION INTERCONNECTION (EVI) LINKS

(71) Applicant: HANGZHOU H3C TECHNOLOGIES CO., LTD., Hangzhou, Zhejiang (CN)

(72) Inventor: Yiming DU, Beijing (CN)

(21) Appl. No.: 14/651,602

(22) PCT Filed: Dec. 23, 2013
(86) PCT No.: PCT/CN2013/090185

§ 371 Date: Jun. 11, 2015

(30) Foreign Application Priority Data
Dec. 27, 2012 (CN) 201210583884.9

(51) Int. Cl. H04L 12/741

(52) U.S. Cl. CPC H04L 45/74

(57) ABSTRACT

The present disclosure describes an example of a method for transmitting a first message and a second message on an Ethernet Virtualisation Interconnection (EVI) link. In this example, the first message is transmitted on the EVI link via a first transmission path identified by a first pair of IP addresses, and the second message is transmitted on the EVI link via a second transmission path identified by a second pair of IP addresses. The first message and the second message are forwarded by a flow-based forwarding device having a plurality of interfaces.

### BACKGROUND

In order to improve reliability and provide redundancy, enterprise networks and data centres may span across a number of network sites which may be geographically dispersed. Ethernet Virtualisation Interconnection (EVI) technologies may be used to provide a virtual layer 2 connection between sites over a layer 3 network. Layer 2 refers to layer 2 of the Open Systems Interconnection (OSI) model, while layer 3 refers to layer 3 of the OSI model. For example EVI may use a “MAC (Media Access Control) in IP” technology to implement a layer 2 overlay network over a layer 3 service provider network. An EVI network may maintain routing and forwarding information on an edge device (ED) of a site network. In the present disclosure, the term “EVI” is used to describe such technologies, but other terms may be used by a person skilled in the art to describe the same or similar functions or technologies without departing from the scope of the present disclosure.

### BRIEF DESCRIPTION OF THE DRAWINGS

Features of the present disclosure are illustrated by way of non-limiting examples, and like numerals indicate like elements, in which:

FIG. 1a is an illustrative diagram of a communication network according to an example;

FIGS. 1b, 1c and 1d are example structures of messages transmitted in the communication network;

FIGS. 2a and 2b are examples of Ethernet Virtualisation Interconnection (EVI) forwarding tables for Edge Devices;

FIG. 2c is an example of a decapsulation table for Edge Devices;

FIG. 3a is an example of a device for associating Internet Protocol (IP) addresses with an EVI link;

FIG. 3b is an example of a device for associating a Medium Access Control (MAC) address with a tunnel;

FIG. 3c is an example of a device for encapsulating messages in an EVI network;

FIG. 3d is an example of a device for transmitting messages in the EVI network;

FIG. 4a is an example flow chat for associating IP addresses with an EVI link;

FIG. 4b is an example flow chat for associating a MAC address with a tunnel;

FIG. 5a is an example flow chat for encapsulating IP address pairs in messages in an EVI network; and

FIG. 5b is an example flow chat for transmitting messages in an EVI network through transmission paths.

### DETAILED DESCRIPTION OF THE INVENTION

The present disclosure describes an example of a method for transmitting a first message and a second message on an Ethernet Virtualisation Interconnection (EVI) link to be forwarded by a flow-based forwarding device having a plurality of interfaces. The first message is transmitted on the EVI link via a first transmission path identified by a first pair of Internet Protocol (IP) addresses. The second message is transmitted on the EVI link via a second transmission path identified by a second pair of IP addresses. The first transmission path and the second transmission path are different for the flow-based forwarding device. In this example, traffic congestion on the EVI link is reduced as the flow-based forwarding device forwards the messages via different transmission paths through different interfaces.

The present disclosure further describes an example of a network device for transmitting a first message and a second message on an Ethernet Virtualisation Interconnection (EVI) to be forwarded by a flow-based forwarding device having a plurality of interfaces. The network device comprises a memory unit to store instructions, and a transmitting unit. The transmitting unit performs the instructions from the memory unit to transmit the first message on the EVI link via a first layer 2 tunnel through a layer 3 network, and to transmit the second message on the EVI link via a second layer 2 tunnel through the layer 3 network.

The present disclosure further describes an example of a network device for associating Internet Protocol (IP) addresses with an Ethernet Virtualisation Interconnection (EVI) link. The network device comprises a memory unit to store instructions; and a transmission path unit. The transmission path unit performs the instructions from the memory unit to associate a first pair of IP addresses with the EVI link to identify a first transmission path for the EVI link and to associate a second pair of IP addresses with the EVI link to identify a second transmission path for the EVI link.

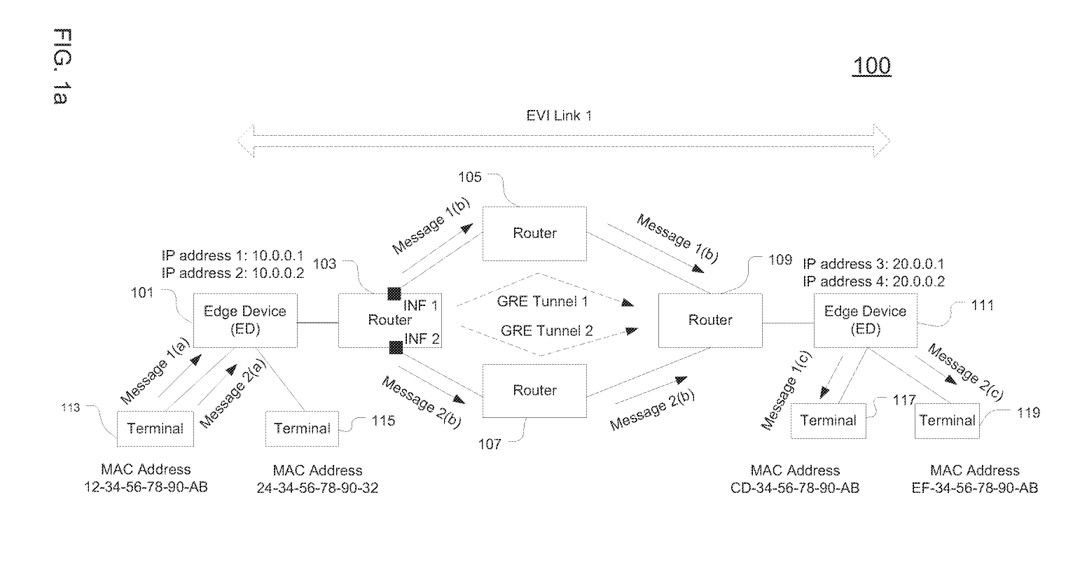

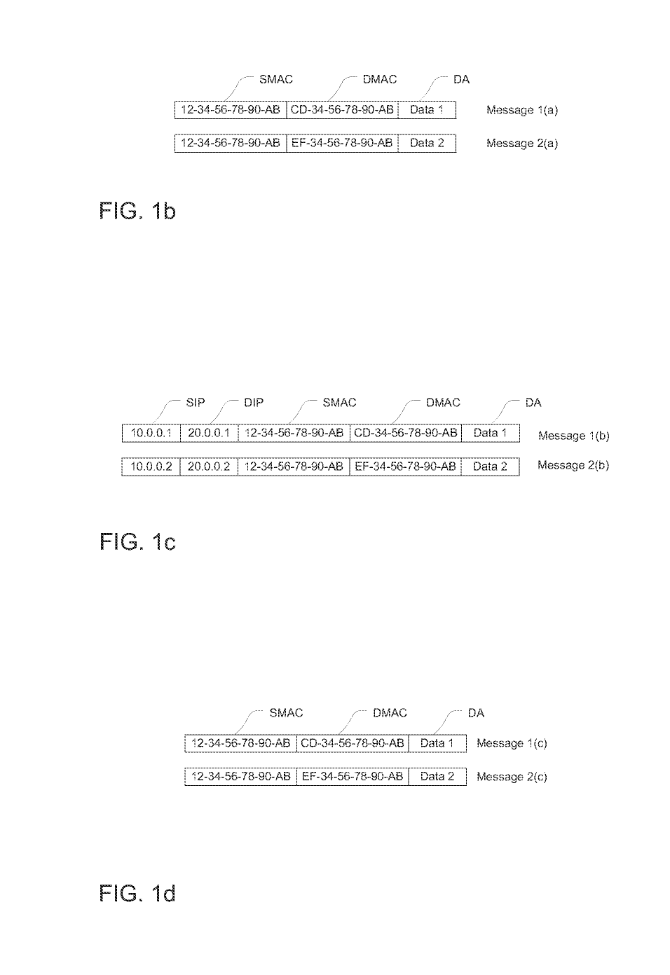

In the example shown in FIG. 1a, a communication network 100 includes a core network, an Ethernet Virtualisation Interconnection (EVI) network, and a Virtual Local Area Network (VLAN) having two site networks.

A first site network having terminals 113 and 115 in the VLAN is connected to the core network via an Edge Device (ED) 101. A second site network having terminals 117 and 119 in the VLAN is connected to the core network via an ED 111. A Medium Access Control (MAC) address is used to identify each terminal in the VLAN. For example, as shown in FIG. 1a, the MAC address of the terminal 113 is 12-34-56-78-90-AB, the MAC address of the terminal 115 is 24-34-56-78-90-32, the MAC address of the terminal 117 is CD-34-56-78-90-AB and the MAC address of the terminal 119 is EF-34-56-78-90-AB.

The core network includes routers 103, 105, 107 and 109 providing IP routing services to interconnect the two site networks. In the communication network 100, the router 103 is a flow-based forwarding device. That is, if two different messages to be forwarded by the router 103 have the same source IP address and the same destination IP address, the router 103 forwards the messages via the same interface, otherwise, the router forwards the messages via different interfaces. This static nature of a flow-based forwarding device makes it efficient to determine which interface the messages should be forwarded to.

The EVI network is a virtual network comprising the EDs 101 and 111 to provide layer-2 interconnection between the site networks. The EDs 101 and 111 are identified by the respective IP addresses. It should be noted that although each of the EDs 101 and 111 are identified by two IP addresses, more or less IP addresses can be used to identify the ED 101 or 111. Further, the IP addresses identifying the ED 101 or 111 are different in this example, but they can also be the same in some circumstances as described below.

Between the EDs 101 and 111 there is a virtual link, shown as an EVI link 1 in FIG. 1a. The EVI link 1 is a bi-directional virtual Ethernet channel between the EDs 101 and 111. The EVI link 1 is carried by a layer 2 tunnel through the layer 3 network, e.g. a Generic Routing Encapsulation (GRE) tunnel. That is, the tunnel acts as a transmission path for transmitting messages on the EVI link 1. According to the GRE protocol, a source Internet Protocol (IP) address field is encapsulated in the messages containing a source IP address and a destination IP address field is encapsulated in the messages containing a destination IP address. It should be noted that the GRE tunnel can carry a plurality of EVI links (not shown in FIG. 1a as there is one pair of EDs 101 and 111 shown in FIG. 1a) to carry traffic in the VLAN. Establishing the EVI link 1 is described below.

In the EVI network, the EDs 101, 111 discover each other and establish the EVI link 1 through a neighbour discovery process according to EVI Neighbour Discovery Protocol (ENDP).

Specifically, an EVI Neighbour Discovery Server (ENDS) and an EVI Neighbour Discovery Client (ENDC) are deployed on the EDs 101 and 111. According to the ENDP, the ENDS is responsible for maintaining device information such as IP addresses and device identification of devices in the EVI network. In the example shown in FIG. 1a, the ENDC of the ED 101 sends to the ENDS of the ED 111 a register request including the device information of the ED 101. In response, the ENDS of ED 111 sends to the ENDC of the ED 101 a reply message including the device information of the ED 111. Once the reply message is received at the ED 101, the EVI link 1 is established between the EDs 101 and 111.

After the neighbour discovery process as described above is performed on all EDs in the EVI network, the EDs in the EVI network discover all other EDs and EVI links are established therebetween.

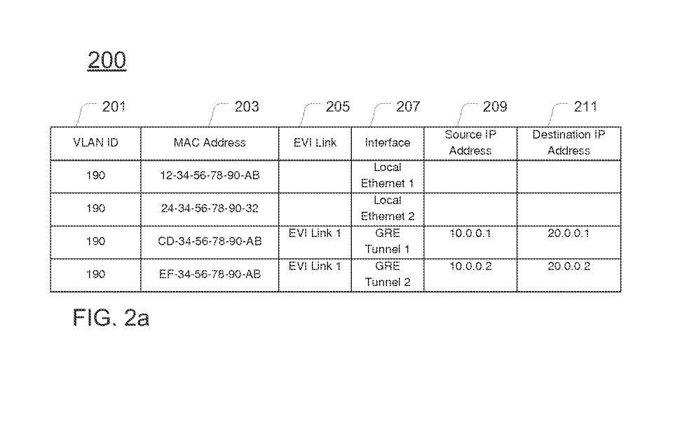

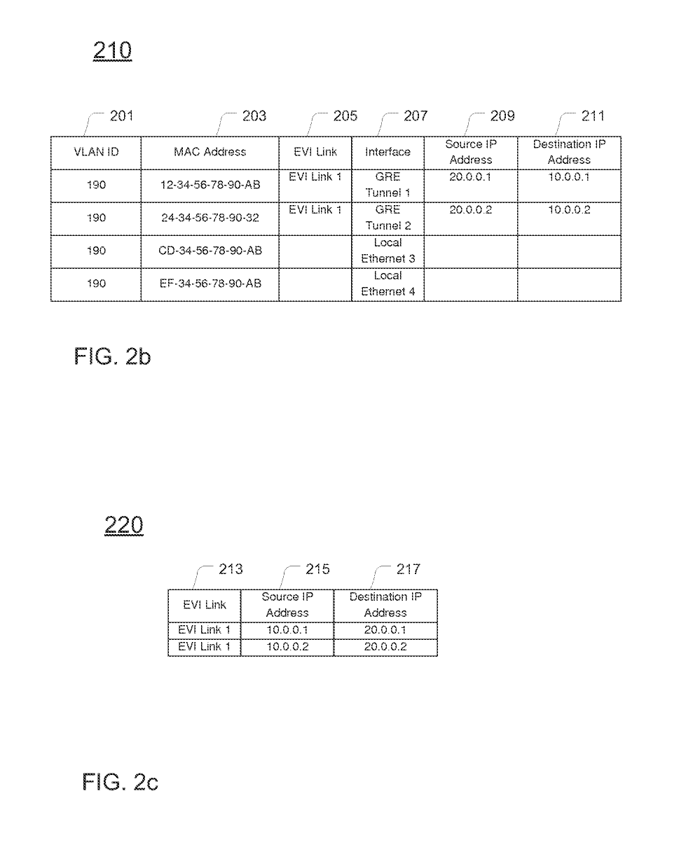

FIGS. 2a and 2b are examples of EVI forwarding table for the EDs 101 and 111 to transmit messages on the EVI link.

The ED 101 has an EVI forwarding table 200 as shown in FIG. 2a. The EVI forwarding table 200 is for the ED 101 to transmit a message it receives from the first site network or the core network. The ED 111 has an EVI forwarding table 210, as shown in FIG. 2b, for the ED 111 to transmit a message it receives from the second site network or the core network. The EVI forwarding tables 200 and 210 include a VLAN field 201, a MAC Address field 203, an EVI Link field 205, an Interface field 207, a Source IP Address field 209 and a Destination IP Address field 211.

Take the third entry for the EVI forwarding table 200 as an example, the VLAN field 201 indicates that this entry is for the ED 101 to transmit a message sent to a terminal in a VLAN identified by a VLAN ID of 190. Since there is one VLAN in the communication network 100 shown in FIG. 1a, the VLAND ID field 201 for all entries has the same VLAN ID of 190. The MAC address field 203 indicates this entry is for the ED 101 to transmit a message to a terminal having a MAC address of CD-34-56-78-90-AB, which is the MAC address of the terminal 117 in the second site network. The EVI Link field 205 indicates that the ED 101 sends the message on the EVI link 1. The Interface field 207 indicates that the EVI Link 1 is carried by the GRE Tunnel 1. The source IP address and the destination IP address associated with the GRE Tunnel 1 are 10.0.0.1, 20.0.0.1 respectively, as indicated by the Source IP Address field 209 and the Destination IP Address field 211. As shown in FIGS. 1a and 2a, the source IP address is one of the IP addresses of the ED 101, and the destination IP address is one of the IP addresses of the ED 111.

Take the fourth entry for the EVI forwarding table 200 as another example, for messages to be sent to a terminal having a MAC address of EF-34-56-78-90-AB, which is the MAC address of the terminal 119 in the second site network, the ED 101 uses another GRE tunnel with which a source IP address of 10.0.0.2 and a destination IP address of 20.0.0.2 are associated.

Further, as shown in the first entry for the EVI forwarding table 200, if the ED 101 receives a message to be transmitted to a terminal having a MAC address of 12-34-56-78-90-AB, which is the MAC address of the terminal 113 in the first site network, then the ED 101 simply transmits the message to the terminal 113 through a local Ethernet interface identified by Local Ethernet 1 not a GRE tunnel.

FIG. 2c is an example of a decapsulation table 220 for the ED 111 to decapsulate messages received from the core network. The decapsulation table 200 includes an EVI Link field 213, a Source IP Address filed 215 and a Destination IP Address field 217. It is indicated in the decapsulation table 220 that there are two decapsulation entries for the EVI Link 1, the first one being for messages having a source IP address of 10.0.0.1 and a destination IP address of 20.0.0.1 (i.e., messages received from the GRE Tunnel 1), and the second one being for messages having a source IP address of 10.0.0.2 and a destination IP address of 20.0.0.2 (i.e., messages received from the GRE Tunnel 2).

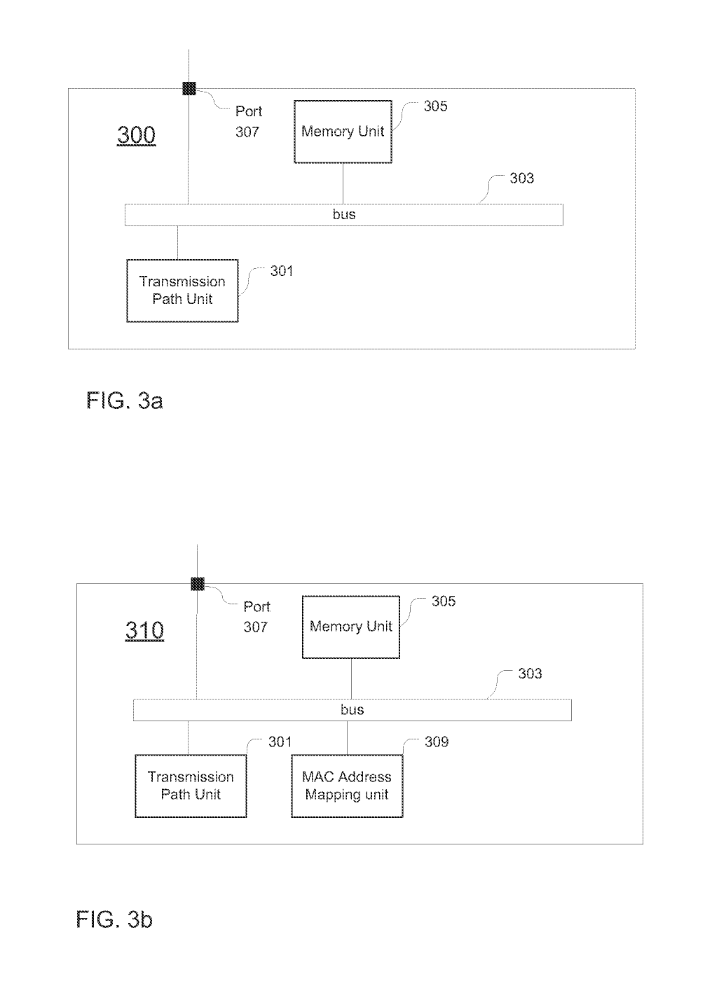

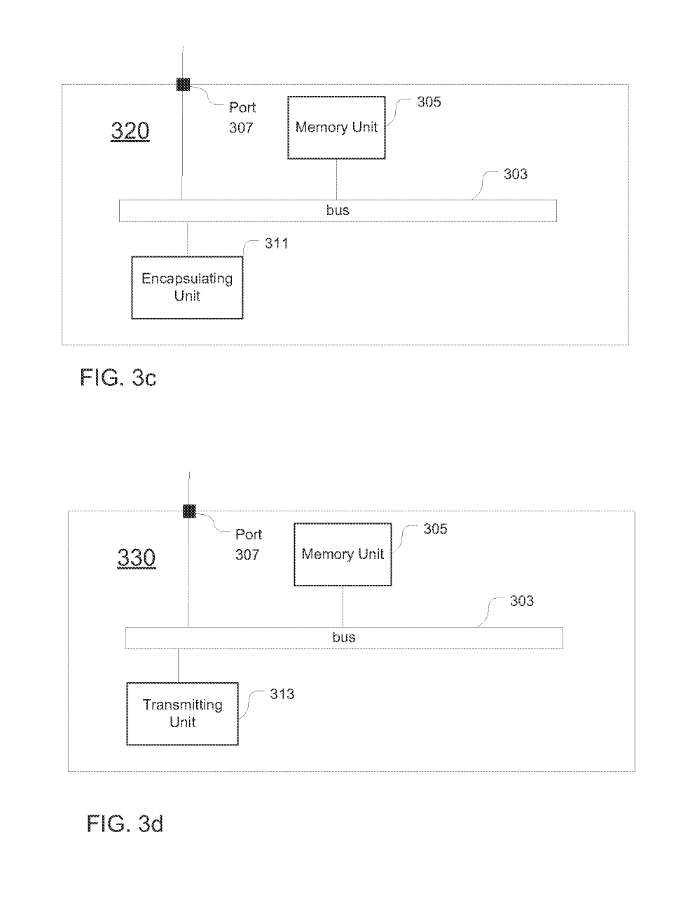

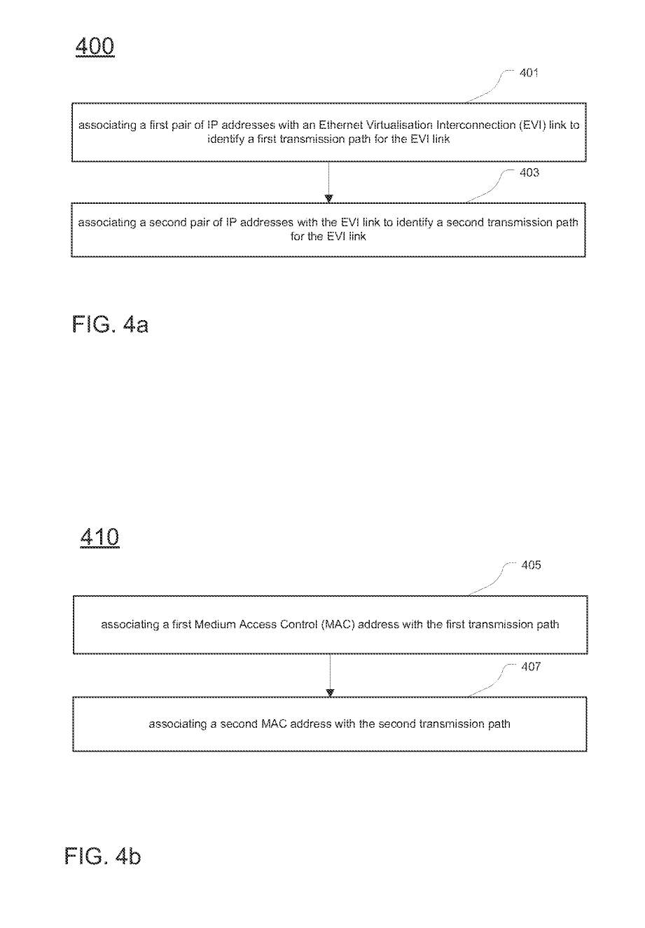

FIG. 3a is an example network device 300 for associating IP addresses with an EVI link. It should be noted that although the network device 300 is shown as an independent device, it can also be part of a device such as the ED 101. The network device 300 is described with reference to FIGS. 2a and 4a.

The network device 300 includes a transmission path unit 301, a bus 303, a memory unit 305 and a port 307. The memory unit 305 stores data and instructions for the transmission path unit 301 to perform functions shown in for example, but not limited to, FIG. 4a. The transmission path unit 301 obtains the data and instructions from the memory unit 305 via the bus 303. The network device 300 communicates, through the port 307, with other entities in the communication network 100 or other parts of a device in which it resides.

In the communication network 100, there are two transmission paths established to transmit messages on the EVI link 1 between the ED 101 and the ED 111. To do that, the transmission path unit 301 associates 401 a first pair of IP addresses with the EVI link 1. One of the first pair of IP addresses, particularly, one of the IP addresses of the ED 101, is used as the source IP address. The other one of the first pair of the IP addresses, particularly, one of the IP addresses of the ED 111, is used as the destination IP address. As shown in the third entry for the EVI forwarding table 200, the source IP address is 10.0.0.1 and the destination IP address is 20.0.0.1. Such an association identifies a first transmission path for the messages on the EVI link 1, i.e., a first GRE tunnel for the EVI Link 1, shown as GRE Tunnel 1 in the EVI forwarding table 200.

Further, the transmission path unit 301 associates 403 a second pair of IP addresses with the EVI link 1. Similar to the first pair of IP addresses, one of the second pair of IP addresses, particularly, one of the IP addresses of the ED 101, is used as the source IP address. The other one of the second pair of the IP addresses, particularly, one of the IP addresses of the ED 111, is used as the destination IP address. As shown in the fourth entry for the EVI forwarding table 200, the source IP address is 10.0.0.2 and the destination IP address is 20.0.0.2. Such an association identifies a second transmission path for the messages on the EVI link 1, i.e., a second GRE tunnel for the EVI Link 1, shown as GRE Tunnel 2 in the EVI forwarding table 200.

Since the first pair of IP addresses and the second pair of IP addresses are different, the first transmission path identified by the first pair of IP addresses and the second transmission path identified the second pair of IP addresses are different accordingly. As a result, the flow-based router 103 transmits the messages having different IP address pairs through different interfaces. As shown in FIG. 1a, the flow-based router 103 transmits the messages having the first pair of IP addresses to the router 105 through an interface identified by INF 1, and transmits the messages having the second pair of IP address to the router 107 through another interface identified by INF 2.

It can be seen from FIG. 1a that the first transmission path identified by the first pair of IP addresses includes the ED 101, the router 103, the router 105, the router 109 and the ED 111, whereas the second transmission path identified by the second pair of IP addresses includes the ED 101, the router 103, the router 107, the router 109 and the ED 111. In this way, the messages on the EVI link 1 are distributed to two transmission paths such that traffic congestion on any single transmission path is reduced if there is heavy traffic on the EVI link 1 between the ED 101 and the ED 111.

The transmission path unit 301 then transmits the association of IP address pairs with the EVI link 1 to the ED 111 via a first Intermediate System to Intermediate System (ISIS) protocol message.

Upon receipt of the first ISIS message at the ED 111, the ED 111 generates the entries for the decapsulation table 220 in order to perform decapsulation processing on the messages received from the GRE Tunnels.

Further, in order for the MAC addresses of the terminals 117 and 119 in the second site network to be known by the ED 101, the ED 111 transmits to the ED 101 the MAC addresses of the terminals 117 and 119.

In the communication work 100, there are two terminals 117 and 119 connected to the ED 111. The ED 111 learns the MAC addresses of the terminals 117 and 119 and transmits the MAC addresses to the ED 101 through a second ISIS protocol message. Since there are two transmission paths between the ED 111 and the ED 101, one of them is selected to transmit the second ISIS message including the MAC addresses to the ED 101.

FIG. 3b is an example network device 310 for associating a MAC address with a GRE Tunnel. It should be noted that although the network device 310 is shown as an independent device, it can also be part of a device such as the ED 101. The network device 310 is described with reference to FIGS. 2a and 4b. In addition to the units included in the device shown in FIG. 3a, the network device 310 further includes a MAC address mapping unit 309 to map MAC addresses of terminals to tunnels (e.g. GRE tunnels).

Upon receipt of the MAC addresses of the terminal 117 and 119 at the ED 101, the MAC address mapping unit 309 associates 405 the MAC address of the terminal 117 with the GRE Tunnel 1, and associates 407 the MAC address of the terminal 119 with the GRE Tunnel 2, as shown in the third and fourth entries for the EVI forwarding table 200 in FIG. 2a. In this way, a message to be sent to the terminal 117 is sent by the ED 101 through the first transmission path being the GRE Tunnel 1, and a message to be sent to the terminal 119 is sent by the ED 101 through the second transmission path being the GRE Tunnel 2.

It should be noted that there are many ways for the MAC address mapping unit 309 to associate the MAC addresses of the terminals 117 and 119 with the GRE tunnels, including but not limited to the following:

1. Static Association. In static association, a user manually instructs the MAC address mapping unit 309 to associate the MAC address of the terminal 117 with the GRE Tunnel 1 and the MAC address of the terminal 119 with the GRE Tunnel 2;

2. Sequential Association. In sequential association, ED 101 associates MAC addresses and GRE tunnels according to the sequence of leaning the MAC addresses. For example, if ED 101 receives an ISIS protocol message including the MAC address of the terminal 117 prior to an ISIS protocol message including the MAC address of the terminal 119, the MAC address mapping unit 309 associates the MAC address of the terminal 117 with the GRE Tunnel 1 and the MAC address of the terminal 119 with the GRE Tunnel 2;

3. Hash Association. In Hash association, the MAC address mapping unit 309 calculates a hash value based on a MAC address and associates a MAC address with a GRE tunnel according to the hash value. For example, the MAC address mapping unit 309, based on the hash values of the MAC address of the terminal 117 and the MAC address of the terminal 119, associates the MAC address of the terminal 117 with the GRE Tunnel 1 and the MAC address of the terminal 119 with the GRE Tunnel 2.

The association of GRE tunnels and MAC addresses is stored in the EVI forwarding tables 200 in the memory unit 305.

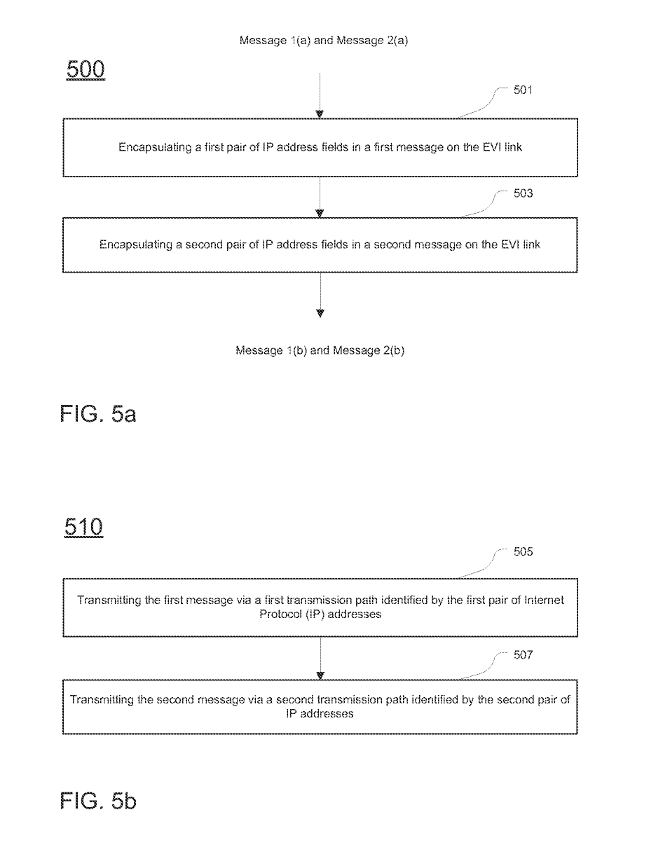

FIG. 3c is an example of a network device 320 for encapsulating messages in the EVI network. FIG. 3d is an example of a network device 330 for transmitting messages in the EVI network. FIGS. 3c and 3d are described with reference to FIGS. 1a, 5a and 5b.

The network device 320 includes a bus 303, a memory unit 305 and a port 307 and an encapsulating unit 311. The memory unit 305 stores data and instructions for the encapsulating unit 311 to perform functions shown in for example, but not limited to, FIG. 5a. The encapsulating unit 311 obtains the data and instructions from the memory unit 305 via the bus 303. The network device 320 communicates, through the port 307, with other entities in the communication network 100 or other parts of a device in which it resides.

The network device 330 includes a bus 303, a memory unit 305 and a port 307 and a transmitting unit 313. The memory unit 305 stores data and instructions for the transmitting unit 313 to perform functions shown in for example, but not limited to, FIG. 5b. The transmitting unit 313 obtains the data and instructions from the memory unit 305 via the bus 303. The network device 330 communicates, through the port 307, with other entities in the communication network 100 or other parts of a device in which it resides.

Although the network devices 320 and 330 are shown as separate devices, they can be part of a device such as the ED 101. For the convenience of describing this example, in the following description, the network devices 320 and 330 are located in the ED 101. Therefore, a reference to the network device 320 or 330 is a reference to the ED 101.

As shown in the communication network 100, if the terminal 113 in the first site network has data to send to the terminal 117 in the second site network, the terminal 113 constructs a message 1(a) shown in FIG. 1b comprising a Source MAC Address (“SMAC” in FIG. 1b) field, a Destination MAC Address (“DMAC” in FIG. 1b) field, and a Data (“DA” in FIG. 1b) field. The SMAC field in the message 1(a) contains the MAC address of the terminal 113 from which the data is sent. The DMAC field in the message 1(a) contains the MAC address of the terminal 117 to which the data is sent. The DA filed contains the data to be sent (Data 1 in the message 1(a)). The message 1(a) is sent by the terminal 113 to the network device 320.

If the terminal 113 in the first site network has data to send to the terminal 119 in the second site network, the terminal 113 constructs a message 2(a) as shown in FIG. 1b. The SMAC field in the message 2(a) contains the MAC address of the terminal 119 from which the data is sent. The DMAC field contains the MAC address of the terminal 119 to which the data is sent. The DA field contains the data to be sent (Data 2 in the message 2(a)). The message 2(a) is then sent by the terminal 113 to the network device 320.

Upon receipt of the message 1(a) at the network device 320, the encapsulating unit 311 of the network device 320 searches the EVI forwarding table 200 stored in the memory unit 305 by the MAC Address field for the MAC address contained in the DMAC field in the message 1(a). In this example, the DMAC address in the message 1(a) is CD-34-56-78-90-AB. As a result, the third entry for the EVI forwarding table 200 is found. As indicated by the third entry for the EVI forwarding table 200, messages to be sent to the MAC address are sent on the EVI link 1 via the GRE Tunnel 1. Further, the source IP address and the destination IP address for the GRE Tunnel 1 are 10.0.0.1 and 20.0.0.1, respectively. Therefore, the encapsulating unit 311 of the network device 320 encapsulates 501 in the message 1(a) a Source IP Address (shown as “SIP” in FIG. 1c) field and a Destination IP Address (shown as “DIP” in FIG. 1c) field, which contain the source IP address and the destination IP address, respectively, as indicated by the third entry for the EVI forwarding table 200, to construct a message 1(b) as shown in FIG. 1c.

Upon receipt of the message 2(a) at the network device 320, the encapsulating unit 311 of the network device 320 searches the EVI forwarding table 200 stored in the memory unit 305 by the MAC Address field for the MAC address contained in the DMAC field in the message 2(a). In this example, the DMAC address in the message 2(a) is EF-34-56-78-90-AB. As a result, the fourth entry for the EVI forwarding table 200 is found. As indicated by the fourth entry for the EVI forwarding table 200, messages to be sent to the MAC address are sent on the EVI link 1 via the GRE Tunnel 2. Further, the source IP address and the destination IP address for the GRE Tunnel 2 are 10.0.0.2 and 20.0.0.2, respectively. Therefore, the encapsulating unit 311 of the network device 320 encapsulates 503 in the message 2(a) a SIP field and a DIP field, which contain the source IP address and the destination IP address, respectively, as indicated by the fourth entry for the EVI forwarding table 200, to construct a message 2(b) shown in FIG. 1c.

Once the message 1(b) is constructed as described above, it is sent 505 by the transmitting unit 311 of the network device 330 to the flow-based router 103 through a first transmission path being the GRE Tunnel 1.

As mentioned above, the router 103 is a flow-based forwarding device. As a result, upon receipt of the message 1(b) having the source IP address of 10.0.0.1 and the destination IP address of 20.0.0.1 at the router 103, the message 1(b) is forwarded to the router 105 via the interface INF 1 of the router 103.

The message 1(b) received at the router 105 is then sent to the router 109, which in turn sends the message 1(b) to the ED 111.

Upon receipt of the message 1(b) at the ED 111, the ED 111 searches the descapsulation table 220 for the source IP address and the destination IP address in the message 1(b). In this example, the first entry for the decapsulation table 220 is found and the ED 111 decapsulates the SIP and DIP fields from the message 1(b) to construct a message 1(c) as shown in FIG. 1d.

The ED 111 then searches the EVI forwarding table 210 by the MAC Address filed for the DMAC address in the message 1(c), which is the MAC address of the terminal 117. In this example, the third entry for the EVI forwarding table 210 is found. As indicated by the third entry, the message 1(c) is sent to the terminal 117 via an interface identified by Local Ethernet 3. Upon receipt of the message 1(c) at the terminal 117, the terminal 117 decapsulates the SMAC field and the DMAC field from the message 1(c) and obtains Data 1.

Once the message 2(b) is constructed at the network device 320 as described above, it is sent 507 by the transmitting unit 313 of the 330 to the flow-based router 103 through a second transmission path being the GRE Tunnel 2.

As the message 2(b) is sent to the router 103 through the GRE Tunnel 2, which is different from the GRE Tunnel 1 through which the message 1(b) is sent to the router 103, the router 103 forwards the message 2(b) via a different interface. Particularly, upon receipt of the message 2(b) having the source IP address of 10.0.0.2 and the destination IP address of 20.0.0.2 at the flow-based router 103, the message 2(b) is forwarded to the router 107 via the interface INF 2 of the router 103.

The message 2(b) received at the router 107 is then sent to the router 109, which in turn sends the message 2(b) to the ED 111.

Upon receipt of the message 2(b) at the ED 111, the ED 111 searches the descapsulation table 220 for the source IP address and the destination IP address in the message 2(b). In this example, the second entry for the decapsulation table 220 is found and the ED 111 decapsulates the SIP and DIP fields from the message 2(b) to construct a message 2(c) as shown in FIG. 1d.

The ED 111 then searches the EVI forwarding table 210 by the MAC Address field for the DMAC address in the message 2(c), which is the MAC address of the terminal 119. In this example, the fourth entry for the EVI forwarding table 210 is found. As indicated in the fourth entry, the message 1(c) is sent to the terminal 119 via an interface identified by Local Ethernet 4. Upon receipt of the message 2(c) at the terminal 119, the terminal 119 decapsulates the SMAC field and the DMAC field from the message 1(c) and obtains Data 2.

As described above, the message 1(b) and the message 2(b) are sent from the ED 101 to the ED 111 through different transmission paths, i.e., the GRE Tunnel 1 and the GRE Tunnel 2. It should be noted that, in this example, the different transmission paths are identified by different source IP addresses and different destination IP addresses. In another example, however, a same source IP address and different destination IP addresses are used to identify different transmission paths. In another example, different source IP addresses and a same destination IP address are used to identify different transmission paths.

It should be noted although that the transmission unit 301 of the network device 300, the MAC address mapping 309 of the network device 310, the encapsulating unit 311 of the network device 320 and the transmitting unit 313 of the network device 330 are shown as separate units, these units may be implemented by a same component, for example, a central processing unit (CPU) of the ED 101, an Application-specific integrated circuit (ASIC), an field-programmable gate array (FPGA) or combinations thereof.

Further it will be appreciated that the network devices described in the present disclosure may be any routers, and switches etc. for transmitting messages or forwarding traffic in a network.

Further, the processes, methods and functional units described in this disclosure may be implemented in the form of a computer software product. The computer software product is stored as machine-readable instructions on a non-transitory storage medium and comprises a plurality of instructions for making a processor to implement the methods recited in the examples of the present disclosure. The processor can be a CPU, an ASIC, a FPGA or their combinations.

The figures are illustrations of an example, wherein the units or step flows shown in the figures are not necessarily essential for implementing the present disclosure. Those skilled in the art will understand that the units in the devices in the examples can be arranged as described, or can be alternatively located in one or more devices differently than shown in the examples. For example, the units in the examples described can be combined into one module or further divided into a plurality of sub-units.

Although the flow charts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

Throughout the present disclosure, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the above-described examples, without departing from the broad general scope of the present disclosure. The present examples are, therefore, to be considered in all respects as illustrative and not restrictive.

1. A method for transmitting a first message and a second message on an Ethernet Virtualisation Interconnection (EVI) link to be forwarded by a flow-based forwarding device having a plurality of interfaces, the method comprising:
transmitting the first message on the EVI link via a first transmission path identified by a first pair of IP addresses; and
transmitting the second message on the EVI link via a second transmission path identified by a second pair of IP addresses.

2. The method according to claim 1, the method comprising:
associating the first pair of IP addresses with the EVI link to identify the first transmission path for the EVI link; and
associating the second pair of IP addresses with the EVI link to identify the second transmission path for the EVI link.

3. The method according to claim 2, further comprising:
associating a first Medium Access Address (MAC) address with the first transmission path; and
associating a second MAC address with the second transmission path.

4. The method according to claim 3, further comprising:
encapsulating a first pair of IP address fields in a first message on the EVI link, wherein the first pair of IP address fields contains the first pair of IP addresses, and
encapsulating a second pair of IP address fields in a second message on the EVI link, wherein the second pair of IP address fields contains the second pair of IP addresses.

5. The method according to claim 1, wherein the first transmission path is a first Generic Routing Encapsulation (GRE) tunnel, the second transmission path is a second GRE tunnel.

6. A network device for associating Internet Protocol (IP) addresses with an Ethernet Virtualisation Interconnection (EVI) link, the network device comprising:
a memory unit to store instructions;
a transmission path unit to perform the instructions from the memory unit to associate a first pair of IP addresses with the EVI link to identify a first transmission path for the EVI link and to associate a second pair of IP addresses with the EVI link to identify a second transmission path for the EVI link.

7. The network device according to claim 6, further comprising a Medium Access Control (MAC) address mapping unit to associate a first MAC address with the first transmission path and to associate a second MAC address with the second transmission path.

8. The network device according to claim 6, the network device further comprising:
an encapsulating unit to encapsulate a first pair of IP address fields in a first message on the EVI link, and to encapsulate a second pair of IP address fields in a second message on the EVI link, wherein the first pair of IP address fields contains the first pair of IP addresses and the second pair of IP address fields contains the second pair of IP addresses.

9. The network device according to claim 6, wherein the first transmission path is a first Generic Routing Encapsulation (GRE) tunnel, the second transmission path is a second GRE tunnel.

10. A network device for transmitting a first message and a second message on an Ethernet Virtualisation Interconnection (EVI) to be forwarded by a flow-based forwarding device having a plurality of interfaces, the network device comprising:
a memory unit to store instructions;
a transmitting unit to perform the instructions from the memory unit to transmit the first message on the EVI link via a first layer 2 tunnel through a layer 3 network, and to transmit the second message on the EVI link via a second layer 2 tunnel through a layer 3 network.

11. The network device according to claim 10, wherein the first tunnel is associated with a first pair of Internet Protocol (IP) addresses, the second tunnel is associated a second pair of IP addresses.

12. The network device according to claim 10, wherein the first tunnel is a Generic Routing Encapsulation (GRE) tunnel and the second tunnel is a GRE tunnel.
